(19) United States
(12) Patent Application Publication
(10) Pub. No.: US 2008/0314334 A1
(43) Pub. Date: Dec. 25, 2008

(54) Device and Method for Controlling Animal Behavior

(75) Inventor: James Dalton, Morgantown, WV (US)

Correspondence Address: CONNOLLY BOVE LODGE & HUTZ LLP, 1875 EYE STREET, N.W., SUITE 1100, WASHINGTON, DC, 20006, US

(73) Assignee: GARDEN GUARDIAN, INC., West Virginia, VA (US)

(21) Appl. No.: 11/719,055

(22) PCT Filed: Nov. 10, 2005
(86) PCT No.: PCT/US2005/040885

§ 371 Date: Mar. 31, 2008

Related U.S. Application Data
(60) Provisional application No. 60/626,442, filed on Nov. 10, 2004.

(30) Foreign Application Priority Data
Nov. 10, 2004 (US) 60626442

(51) Int. Cl. A01K 15/04

(52) U.S. Cl. 119/719

(57) ABSTRACT

A device and method for deterring animals from entering a predetermined area. The device and method for deterring animal behavior can greatly increase safety of the animals and increase the safety of the surroundings for humans by limiting personal contact, and by repelling unwanted animals away from an area under protection. In particular, the device and method deters or repels animals from an area under protection by using at least one of mechanical vibrations, sounds, lights and aromas.

### BACKGROUND OF THE INVENTION

The present invention relates to a device and method for deterring animals from a predetermined area. In particular, the present invention is directed to a device and method that repels or deters animals from an area under protection, by using at least one of mechanical vibrations, sounds, lights and aromas.

Animals, such as deer, rabbits, etc., can cause considerable damage as they enter and feed in fields, yards and gardens. Farmers also are troubled by animals that stampede through grain and eat or damage crops.

In the background art, fences and the like have been used to deter animals from causing the type of damage discussed above. Though fences can have the desired effect of keeping the animals away, the cost of building a fence strong enough to deter relatively large wild animals (e.g., deer) can be prohibitively expensive due to construction costs (e.g., height and strength of fencing required to repel large animals) and often must be electrified to be effective.

Other background art devices for deterring animals utilize animal limiting means to deter an undesired action or promote a desired action from an animal. For example, U.S. Pat. No. 5,009,192 discloses a device for deterring animals where at least one water sprinkler is used as the animal limiting means. In the 192′ patent, sprinklers produce a sudden jet of water to frighten or startle an animal away from the predetermined area. However, the device of the 192′ patent may be cost prohibitive for deterring animals because the sprinklers would necessitate installing a water line to each device.

Another background art example is shown in U.S. Pat. No. 5,892,446 which discloses an animal deterrent device that uses a light source and a pre-tuned radio to deter wild animals from entering a predetermined area. Upon detecting the presence of an animal with a heat and motion sensor, the light and radio are activated. The combination of visual and auditory stimulants work together to frighten the animal away from the predetermined area.

However, a problem with these and similar background art devices and methods for deterring animals is that, over time, the targeted animals can become accustomed or desensitized to the stimulus of the animal limiting means of the device. For example, the animals may become accustomed to the constant stimulation of their senses by water, light or sound emitted from the animal deterring limiting means of the device in the same way that one becomes accustomed or desensitized to the constant barking of a dog or sounding of an alarm. The desensitization of animals to these background art animal deterring devices results in the decreased effectiveness of the above-discussed animal limiting means and increased numbers of unwanted animals invading predetermined areas such as gardens, homes, and roadways.

Therefore, there is a need in the art for a device and method for repelling or deterring animals from predetermined areas that is cost effective and not prone to desensitize the target animals over time. Moreover there is a need in the art for a device and method for deterring animals that does not harm the animals or the environment.

### BRIEF SUMMARY OF THE INVENTION

The present invention is a device and method for deterring animal behavior that can greatly increase safety of the animals and increase the safety of the surroundings for humans by limiting personal contact, and by repelling or deterring unwanted animals away from predetermined areas.

One embodiment of the present invention is a device for deterring animals comprising: an enclosure; at least one spike configured to secure the enclosure to a surface and transfer energy in the form of mechanical vibrations to the surface; a sensor configured to detect the presence of an animal near a predetermined area; at least one animal limiting unit configured to generate a stimulus to deter a detected animal from entering the predetermined area; and a control unit with means for varying the stimulus of the at least one animal limiting unit in a random fashion. Preferably the animal limiting unit is at least one of a mechanical vibration-based unit, a noise-based unit, a light-based unit, and an aroma generator based unit. Preferably, the means for varying includes but is not limited to microprocessors, microcontrollers, digital logic and other conventional electronics for programmed control.

Another embodiment of the invention is a method for deterring animals comprising: sensing the presence of an animal near a predetermined area; generating at least one animal limiting stimulus; and varying the period of time at least one animal limiting stimulus is generated in at least one of a fixed and random fashion. Preferably, the animal limiting stimulus is based on at lease one of mechanical vibrations, noise frequencies, lights and aromas.

### BRIEF DESCRIPTION OF DRAWINGS

FIG. 1 shows an exemplary schematic diagram of the present invention; and

FIG. 2 shows an exemplary flow diagram of the present invention.

### DETAILED DESCRIPTION OF THE INVENTION

The present invention is a device triggered by the presence of an animal that is to be repelled or deterred from entering a predetermined area. The device and method of the present invention is a randomized, non-duplicating scheme for deterring or repelling animals at least due to mechanical vibrations of the ground or another surface and that may further include at least one of three additional types of animal limiting means that stimulate the more highly developed senses (e.g., auditory, visual, olfactory (i.e., smell)) of an unwanted animal. Stimulating these senses promotes a reaction similar to fear and panic within each animal. Due to the randomized selection of mechanical vibrations, lights and aromas, animals cannot become accustomed or desensitized to the animal limiting stimuli of the animal deterring device and thus, cannot learn to ignore or disregard the device as harmless.

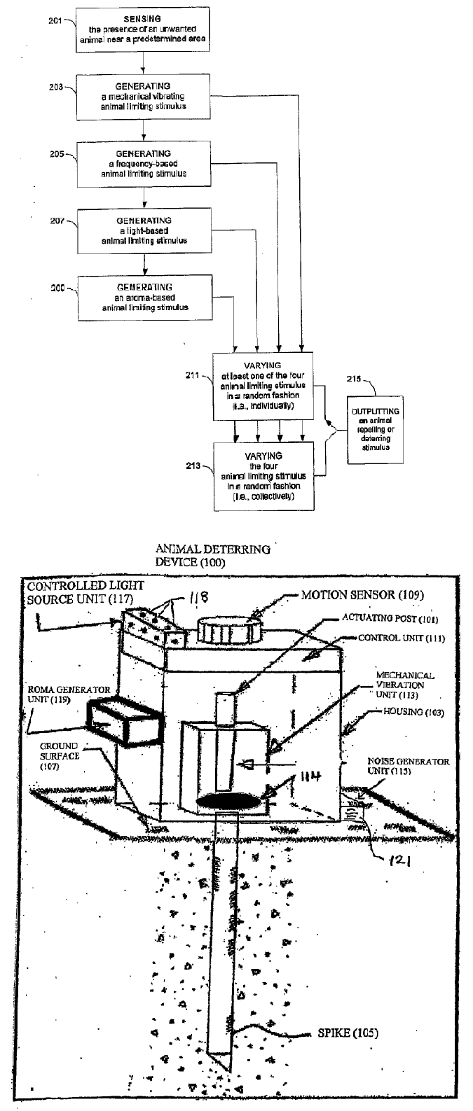

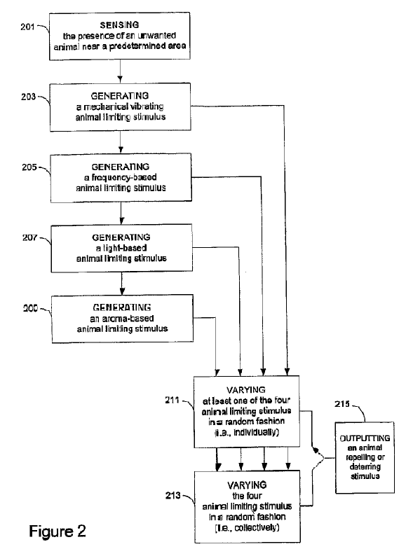

FIG. 1 shows an exemplary schematic diagram of the animal deterring device 100 of the present invention. FIG. 2 shows an exemplary flow diagram of the method for deterring animals of the present invention animal 101. Both figures are further described in the following paragraphs.

As shown in FIG. 1, the animal deterring device 100 includes an enclosure or a housing 103 that is attached to at least one spike 105. The at least one spike 105 is driven into the ground 107 or some other surface so that the enclosure or housing 103 is fixed to the ground 107 or other surface. Alternatively, the animal deterring device 101 may include a plurality of spikes 105. The animal deterring device 101 includes a sensor 109 to detect the presence of an animal near the predetermined area. Examples of the sensor 109 that are to be used with the present invention include, but are not limited to: motion sensors, infra-red sensors, and heat sensors. Upon sensor 109 detecting an unwanted animal near the predetermined area, the animal deterring device 100 operates at least one of the four animal limiting means to repel or deter the animal from approaching the predetermined area.

In addition, as shown in FIG. 1, the animal deterring device 100 includes a control unit 111 that operates, in a random fashion, at least one of four animal limiting means that are used to deter the animal from entering the predetermined area. As shown in FIG. 1, the animal limiting means include, but are not limited to, a mechanical vibration unit 113, a noise generator unit 115, a controlled light source unit 117 and an aroma generator based unit 119.

Further, the control unit 111 is capable of operating each of the at least one of four animal limiting means 113, 115, 117, 119 both individually and collectively. Operating the animal limiting means in a random fashion prevents the targeted animals from becoming desensitized to the stimuli of animal limiting means 113, 115, 117, 119 of the animal deterring device 100.

The control unit 111 is computer-based and can be programmed to provide a pseudo random nature to the operation of each of the animal limiting means 113, 115, 117, 119. Examples of computer-based elements in the control unit 111 include, but are not limited to, microprocessors, microcontrollers and digital logic. The control unit 111 also includes analog electronic components that provide for analog interfaces to at least the solenoid post 101, sensor 109 and speaker 121 of the noise generator unit 115. Analog components include, but are not limited to transistors, amplifiers and analog integrated circuits.

The mechanical vibration unit 113 shown in FIG. 1 is comprised of a solenoid 110 a solenoid post 101, and a spike 105. The mechanical vibrations are created by having the solenoid post 101 on the solenoid 110 transfer energy to the spike 105 either directly or indirectly. The mechanical vibration unit 113 creates a randomly patterned mechanical vibration that is transferred to the ground or another surface via the at least one spike (FIG. 1, 105) that is driven into the ground (FIG. 1, 107) or other surface. The random mechanical vibrations generated by the mechanical vibrations unit 113 are varied in a random fashion by the control unit 111. The mechanical vibrations will be felt by the animal through the ground or other surface and acts to scare the animal away from the predetermined area.

In addition, in a preferred environment the mechanical vibration unit 113 also produces a range of noise frequencies. Preferably, the range of noise frequencies extends from 1 Hz to 100 KHz. The noise frequencies from the mechanical vibration unit 113 are amplified and can be frequency modulated to produce a sound output by the noise generator unit 115 shown in the schematic diagram of FIG. 1. The noise generator unit 115 emits the amplified and frequency modulated sound that is derived from the noise generated by the mechanical vibration unit 113 via a speaker 121. The rate of amplification and frequency modulation of noise frequencies is varied in a random fashion by the control unit 111. The resulting sound emitted by the speaker 121 of the noise generation unit 115 is at an amplitude and in a range of frequencies that is audible to the unwanted animal and will repel or deter the animal from entering a predetermined area. In a preferred embodiment, the noise is produced by having the solenoid post 101 in the solenoid 110 strike a metal plate 114 in the noise generation unit 115 placed between the solenoid post 101 and the spike 105. The metal plate 114 is free to move and may or may not be dimpled.

Further, FIG. 1 shows a controlled light source unit 117 that will be operated by the control unit 111 and produces visual animal limiting means that repel or deter an unwanted animal from entering a predetermined area. The intensity and the on/off cycle time of the light sources 118 of the controlled light source unit 117 are varied in a random fashion that is determined and controlled by the control unit 111. The parameters (i.e., light intensity, on/off cycle time) of the controlled light source unit 117 are varied in a random fashion to repel or deter an unwanted animal from entering a predetermined area. Examples of light sources to be used in the present invention include, but are not limited to light-emitting diodes, incandescent lights, halogen lights and fluorescent lights. At least one of the light sources on the animal deterring device 100 will appear to move by, for example, being rotatably mounted on the animal deterring device 100 such that the light source may be pointed in a desired direction. The controlled light source unit 117 more preferably includes automatic control of the light sources 118 by the control unit 111 in order to direct the light sources in the direction of the animal, as indicated by the sensor 109.

Furthermore, FIG. 1 shows an aroma-based generator unit 119 that produces an animal limiting aroma means that stimulates an animal's sense of smell in a way that will repel or deter an unwanted animal from entering a predetermined area. In a preferred embodiment, the aroma-based generator unit 119 will use, for example, a liquid mist from a pressurized aerosol spray device. Alternatively, gas vapor from a heated material may be used by the aroma-based generator unit 119.

Moreover, the housing 103 of FIG. 1 further includes interface connectors (not shown) to which the animal limiting units 113, 115, 117, 119 are connected. The interface connectors provide the animal limiting units 113, 115, 117, 119 with an electrical connection to the control unit 111 over which electrical signals are sent to control each unit. Examples for the electrical connection include, but are not limited to parallel bus, serial bus, PCIbus, USB, and PMCIA. The housing 103 also includes an internal battery operated power supply (not shown) that supplies stand-alone power to the animal deterring device 100.

FIG. 2 shows an exemplary flow diagram of the method of the present invention. Step 201 of FIG. 2 is sensing the presence of an unwanted animal near a predetermined area. In Step 203 to Step 209 of FIG. 2, at least one of four animal limiting means are used to generated animal limiting stimuli that repel or deter the unwanted animal from the predetermined area. In particular, Step 203 involves generating a mechanical vibrating animal limiting stimulus. The mechanical vibrating of Step 203 will always be generated regardless of the use of any other stimuli. In Step 205, a noise frequency or based animal limiting stimulus is generated. Step 207 involves generating a light-based animal limiting stimulus. In Step 209, an aroma-based animal limiting stimulus is generated. Step 211 involves varying at least one of the four animal limiting stimuli of Step 203 to Step 209 in a random fashion. Varying the stimuli prevents the unwanted animal from become accustomed or desensitized to a particular animal limiting stimulus.

In Step 211, at least one of the three additional animal limiting stimuli of Step 205 to Step 209 is output from the animal deterring device to repel or deter the unwanted animal for the predetermined area. Alternatively, Step 211 could provide any two or three of the additional animal limiting stimuli of Steps 205 to Step 209, each of varying in a random fashion, as an output from the animal deterring device 100.

In Step 213, each of the four animal limiting stimuli of Step 203 to Step 209 is output from the animal deterring device to repel or deter the unwanted animal for the predetermined area. Each of the four animal limiting stimuli in Step 203 to Step 209 may be varied individually and the overall period of time (i.e., time interval) each randomly varied animal limiting stimulus is used can also vary in either a fixed or random fashion.

The foregoing description of the present invention provides illustration and description, but is not intended to be exhaustive or to limit the invention to the precise form disclosed. Modifications and variations are possible in light of the above teachings or may be acquired from practice of the invention. The scope of the invention is defined by the claims and their equivalents.

What is claimed is:

1. A device for deterring animals comprising:
an enclosure;
at least one spike configured to secure the enclosure to a surface;
a sensor configured to detect the presence of an animal near a predetermined area;
at least one animal limiting unit configured to generate a stimulus to deter a detected animal from entering the predetermined area; and
a control unit with means for varying the stimulus of the at least one animal limiting unit in a random fashion.

2. The device of claim 1, wherein the at least one animal limiting unit is at least one of a mechanical-vibration-based unit, a noise-based unit, a light-based unit and an aroma-based generator unit.

3. The device of claim 2, wherein the sensor is at least one of a motion sensor, infra-red sensor and heat sensor.

4. The device of claim 2, wherein the mechanical vibration unit further comprises a solenoid, a solenoid post and at least one spike.

5. The device of claim 2, wherein the noise-based unit further comprises an amplifier, frequency modulator and a speaker.

6. The device of claim 2, wherein the light-based unit further comprises further comprises light sources including at least one of light-emitting diodes, incandescent lights, halogen lights and fluorescent lights.

7. The device of claim 6, wherein the light sources are rotatably mounted on the light-based unit.

8. The device of claim 2, wherein the aroma-based generator unit further comprises a pressurized aerosol spray device configured to emit a liquid mist.

9. The device of claim 2, wherein the control unit further comprises at least one of a microprocessor, microcontroller and digital logic.

10. The device of claim 9, wherein the control unit further comprises analog components configured to interface to the at least one animal limiting unit.

11. A method for deterring animals comprising:
sensing the presence of an animal near a predetermined area;
generating at least one animal limiting stimulus; and
varying the period of time the at least one animal limiting stimulus is generated.

12. The method of claim 11, wherein the animal limiting stimulus is at least one of mechanical vibration-based, noise-based, light-based and aroma-based.

13. The method of claim 12, wherein the period of time alternates between predetermined fixed length time intervals.

14. The method of claim 12, wherein the period of time alternates between random length time intervals.
